(19) United States
(12) Patent Application Publication
(10) Pub. No.: US 2006/0229112 A1
(43) Pub. Date: Oct. 12, 2006

(54) Cellular telephone charging station and method

(76) Inventor: Virgilio Mallada Forro, Roselle, IL (US)

Correspondence Address: FACTOR & LAKE, LTD, 1327 W. WASHINGTON BLVD., SUITE 5G/H, CHICAGO, IL, 60607, US

(21) Appl. No.: 11/190,994

(22) Filed: Jul. 27, 2005

Related U.S. Application Data
(60) Provisional application No. 60/669,193, filed on Apr. 6, 2005.

(51) Int. Cl. H04B 1/38; H04M 1/00

(52) U.S. Cl. 455/573; 455/557

(57) ABSTRACT

An apparatus and method is disclosed for allowing a user to charge the battery(s) within a cellular telephone. According to one aspect of the invention, an interface is provided for receiving a payment from a user. In response thereto, a timer is set to operate for a period to time that is based on the amount of the payment. During the time period, a power source is operated for charging the cellular telephone battery via a cord having a connector on at least one end. In accordance with another aspect of the invention, a method is provided. The method includes receiving a payment and, in response thereto, setting a timer to count for an amount of time. The method also includes providing an electrical output suitable for charging at least one cellular telephone battery, and disabling the electrical output when the timer reaches the set amount of time.

### RELATED APPLICATIONS

This application claims the benefit of U.S. Provisional Patent Application Ser. No. 60/669,193, filed Apr. 6, 2005.

### FIELD OF THE INVENTION

The present invention relates to charging of cellular telephone batteries, and in particular, to a device that allows for the charging of a cellular telephone battery in exchange for a monetary payment.

### FEDERALLY SPONSORED RESEARCH OR DEVELOPMENT

None.

### BACKGROUND OF THE INVENTION

Many cellular telephone users have, at one time or another, forgotten to recharge the battery to their phone. Likewise, many users have inadvertently left the phone operating so the battery becomes drained. As a result, the telephone may become inoperable during a time when the user has an urgent need to place a telephone call. Nevertheless, the user is caught without a phone suitable for making important business or emergency calls.

The unique invention disclosed herein provides a solution for allowing a user to charge the battery(s) to a cellular telephone.

### SUMMARY OF INVENTION

The present invention is directed to a charging station that allows a user to charge the battery(s) to a cellular telephone. According to one aspect of the invention, a user interface is provided for receiving a payment from the user. In response to the payment, a timer is set to operate for a period of time based on the amount of the payment. During the period of time, a power source is operated for charging the cellular telephone, via a cord having a connector attached to at least one end of the cord.

According to another aspect of the invention, a method is provided. The method includes receiving a payment and, in response thereto, setting a timer to count for an amount of time. The method also includes providing an electrical output suitable for charging a cellular telephone, wherein the electrical output is disabled when the timer counts to the time limit.

Other embodiments, systems, methods, features, and advantages of the present invention will be, or will become, apparent to one having ordinary skill in the art upon examination of the following drawings and detailed description. It is intended that all such additional systems, methods, features, and advantages included within this description be within the scope of the present invention, and be protected by the accompanying claims.

### DESCRIPTION OF THE DRAWINGS

The invention may be better understood with reference to the following drawings. The components in the drawings are not necessarily to scale, emphasis instead being placed upon illustrating the principles of the invention. In the drawings, like reference numerals designate corresponding parts throughout the several views.

FIG. 1 is a perspective view of a cellular telephone charging station in accordance with the present invention for charging the battery of a cellular telephone; and,

FIG. 2 is a simplified block diagram of the cellular telephone charging station of FIG. 1.

### DESCRIPTION OF DETAILED EMBODIMENTS

The following descriptions of detailed embodiments are for exemplifying the principles and advantages of the inventions claimed herein. They are not to be taken in any way as limitations on the scope of the inventions.

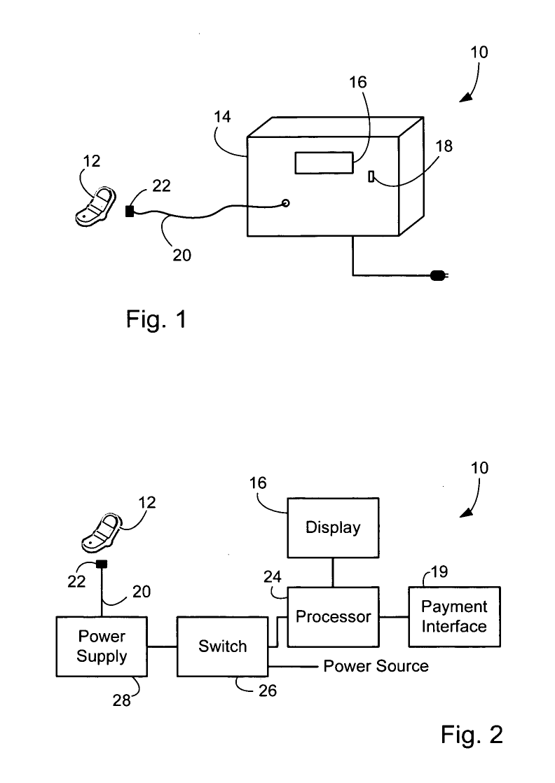

Turning to the FIGURES, and in particular to FIG. 1, a perspective view of a cellular telephone charging station 10 in accordance with the present invention is depicted for charging the battery (not shown) of a cellular telephone 12. The charging station 10 includes, but is not necessarily limited to, a housing 14 having a plurality of user interfaces such as, but not limited to, a visual display 16, a coin entry slot 18, and at least one electrical cord 20.

The housing 14 can be metal, metal alloy, or plastic. The housing 14 can be suitable for mounting, in a conventional manner, to a fixture or fixed structure such as a wall or the like. The housing 14 can include a lockable door for accessing the inside of the housing to perform maintenance and remove monies from within the housing.

The coin entry slot 18 allows for a user to deposit money into the housing. As explained in detail further herein, in exchange for the money deposited, the station 10 provides the user with electrical power for charging the battery of the cellular telephone 12.

Although a coin slot 18 is shown in the embodiment of FIG. 1, it is to be understood that, in alternative embodiment, the station 10 can include alternative interfaces or ways of receiving money or payment from a user including, but not limited to, an electromechanical paper currency or dollar bill validator, a credit or debit card reader, a radio frequency identification system, or other wireless methodology for making a purchase transaction. In yet another embodiment, the station 10 can include multiple interfaces or means for receiving money from a user including, but not limited to, having both a conventional bill validator, coin validator, and a credit card reader.

The display 16 can provide a user with instructional and status information. In an embodiment, the information can include instructions for directing the user in making a purchase transaction, instructions on when and how the user can connect his or her cellular telephone 12 to the station, the status regarding the progress in charging the cellular telephone, and the time remaining in charging the battery based upon the amount of money deposited by the user.

In yet another embodiment, the display 16 can be a conventional device suitable for both displaying information and receiving touch inputs from a user. Thus, via the display, a user can enter data by touching the display in response to messages, questions, or other information being displayed.

The electrical cord 20 extends from the housing 14 and includes a connector 22 attached to its distal end. The electrical cord 20 can be both extendable and tractable from the housing 14, such as by using a conventional retractable cord reel or the like that is mounted within the housing.

The connector 22 can be of a male or female type, and is suitable for connecting the cord 20 to the make and model of the cellular telephone to be charged. In yet another embodiment, the connector 22 can include multiple male and/or female fittings for connecting to more than one make and/or model of cellular telephone. In a further embodiment, the station 10 can be provided with multiple connectors, extending from multiple cords, wherein each of the connectors is suitable for connecting to a different make and/or model of cellular telephone.

As shown in FIG. 1, the station 10 can be powered by a conventional electrical power source, such as by plugging the station into a conventional wall outlet. In yet another embodiment, the station 10 can be power by a battery, gas-electric generator, fuel cell, or other conventional means.

Turning to FIG. 2, the station 10 can include a computer 24 operative connected to the interface 19 for receiving payment, the display 16, and a switch 26. The computer 24 can include, but is not limited to, a conventional microprocessor or a microcontroller. The computer 24 receives input from the interface 19 for receiving payment. This input includes, but is not necessarily limited to, the amount of money or payment the station has received from a user.

The switch 26 is operatively connected to both an electrical power source, as described previously, and an electrical power supply 28. The switch 26 is controlled by the computer 24 wherein, in response to commands from the computer, the switch closes and opens the connection between the power supply 28 and the electrical power source. Accordingly, in an embodiment, in response to the amount of money inserted into the station, the computer 24 toggles the switch 26 to a closed position to enable operation of the power supply 28, and later the computer opens the connection once a predetermined amount of time has elapsed for disabling operation of the power supply. Thus, the computer provides a function similar to a timer wherein the initial amount of time for operation of the power supply 28 is determined by the amount of money entered into the station by the user (i.e., customer).

For instance, the initial amount of time can be set to five (5) minutes for one (1) dollar, and fifteen (15) minutes for two (2) dollars. As will be appreciated by those having ordinary skill in the art, the timer function can be performed by the computer 24 executing computer code stored within a memory.

The power supply 28 can be a conventional device suitable for supplying power to the customer's cellular telephone 12, and thus the battery. For instance, in an embodiment, the power supply 28 can be the cellular telephone manufacture's battery charger. In yet another embodiment, the power supply 28 can be a conventional converter for converting an alternating current into a direct current suitable for plugging into the cellular telephone 12 at charging its battery.

In a further embodiment, the power supply 28 can be a step up or down transformer for converting a voltage input (i.e., 220 volts AC) into a different voltage output (i.e., 110 volts AC). In this embodiment, the station 10 can include an outlet wherein the customer can plug his or her own cellular telephone battery charger into the outlet. For instance, a customer in a country where the standard outlet voltage is 220 volts AC can used the station to provide a 110 volts AC output for operating his or her own cellular telephone battery charger that requires the 110 volts AC output to operate correctly.

In yet another embodiment, the power supply 28 can be a converter for converting a voltage input into 12 Volts DC. In this embodiment, the station 10 can include a power port, such as found in many automobiles for a cigarette lighter or the like, wherein the customer could plug his or her own car adapter (i.e., car powered cellular telephone battery charger) into the port for charging the cellular telephone 12.

The display 16 is operatively connected to the computer 24 for allowing the computer 24 to present information, via the display, to the user. For instance, the display 16 can present instructional or marketing information for making the user aware of the services provided by the station. Further, the display 16 can provided the user with information such as the amount of time the station will remain operating (i.e., charging the cellular telephone battery) based on the amount of the payment made by the user.

It should be emphasized that the above-described embodiments of the present invention, particularly, any “preferred” embodiments, are possible examples of implementations merely set forth for a clear understanding of the principles of the invention. Many variations and modifications may be made to the above-described embodiment(s) of the invention without substantially departing from the spirit and principles of the invention. For instance, the station can provide multiple power cords and user interfaces for simultaneously charging the cellular telephone batteries of multiple users. Moreover, the operation of the user interface 19 can be performed by an attendant that collects payments from users and sets the duration of the charging time. Accordingly, all such modifications are intended to be included herein within the scope of this disclosure and the present invention, and protected by the following claims.

What is claimed is:

1. An apparatus for charging a battery within a cellular telephone comprising:
an interface for receiving a payment;
a timer having an initial time period that is determined by the payment received;
a power supply that is operated until the initial time period has lapsed; and,
a cord operatively attached to the power supply and having a connector to operatively couple the power supply to the cellular telephone.

2. The apparatus of claim 1, wherein the interface is a dollar bill validator.

3. The apparatus of claim 1, wherein the interface is a coin validator.

4. The apparatus of claim 1, wherein the interface is a credit card reader.

5. The apparatus of claim 1, wherein the interface is a debit card reader.

6. The apparatus of claim 1, wherein a computer operates, at least in part, as the timer.

7. The apparatus of claim 1, wherein a microprocessor operates, at least in part, as timer.

8. The apparatus of claim 1, wherein a microcontroller operates, at least in part, as the timer.

9. The apparatus of claim 1, wherein the power supply is a converter.

10. The apparatus of claim 1, wherein the power supply is a step up or down converter.

11. The apparatus of claim 1, wherein the power supply receives an input voltage from a battery.

12. The apparatus of claim 1, wherein the power supply receives an input voltage of 220 volts AC and provides an output voltage of 10 volts AC.

13. The apparatus of claim 1, further comprising a display for providing humanly visible information.

14. The apparatus of claim 1, further comprising a display for providing humanly visible information comprising the time remaining for the power supply to be enabled.

15. The apparatus of claim 1, further comprising a housing containing the timer and mounted within an airport.

16. The apparatus of claim 1, further comprising a housing containing the timer and mounted within a shopping mall, a grocery store, or a school.

17. A method of charging a battery within a cellular telephone comprising the steps of:
receiving a payment;
setting a timer to count to a predetermined time limit in response to the payment received;
providing an electrical output suitable for the charging of the battery within the cellular telephone; and,
disabling the electrical output when the timer counts to the predetermined time limit.

18. The method of claim 1, further comprising the step of displaying an amount of time remaining before the electrical output is disabled.

19. The method of claim 1, further comprising the step of charging the battery within the cellular telephone in an airport, a shopping mall, a grocery store, or a school.

20. A station for charging a battery within a cellular telephone comprising:
a housing mounted in an airport, a shopping mall, a grocery store or a school;
a computer within the housing;
an interface operatively connected to the computer for receiving a monetary amount;
an electrical output that operates during a period of time determined by the monetary amount received; and,
a cord coupled between the electrical output and the cellular telephone.
